(19) United States
(12) Patent Application Publication
(10) Pub. No.: US 2004/0207890 A1
(43) Pub. Date: Oct. 21, 2004

(54) Method and apparatus for controlling shifting of data out of at least one image sensor

(76) Inventors: Curt Paul Breswick, Georgetown, KY (US); Joseph Kamal Yackzan, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/414,664

(22) Filed: Apr. 16, 2003

(51) Int. Cl. H04N 1/04; H04N 1/46

(52) U.S. Cl. 358/514; 358/483

(57) ABSTRACT

Shifting of data out of at least one image sensor is controlled by a programmable sequencer table. Sampling of the shifted data is also controlled by the sequencer table. The sequencer table is programmed with at least one pattern for controlling shifting of data out of the image sensor and sampling of the shifted data. The pattern programmed into the sequencer table depends upon the image sensor. Output of the pattern from the sequencer table is controlled by a sequencer control block. The sequencer table and the sequencer control block may be included in a single application specific integrated circuit which may be implemented in, e.g., a scanner. This provides flexibility in the selection of image sensors, without requiring different circuits for controlling shifting of data out of the image sensors.

### BACKGROUND

The present invention is directed to a method and apparatus for controlling data shifting. More particularly, the invention is directed to a method and apparatus for controlling shifting of data out of at least one image sensor.

An image sensor is an element in a device, such as a scanner, that collects an image. The sensor stores sensed image data and presents that data to a special purpose analog-to-digital converter, called an Analog Front End (AFE). The analog data is presented to the AFE in a serial fashion (one pixel at a time) in a process referred to as “shifting” the data out of sensor. Each sensor has a digital interface through which the shifting operation is controlled. The AFE, in turn, samples the shifted data.

There are many different types of sensors, including a charge coupled device (CCD) and a contact image sensor (CIS). Each of the different types of sensors have their own advantages. For example, a CCD can produce scan data faster than a CIS and is better at scanning “3D” images that don't come in direct contact with the scanner glass, such as a book that doesn't lie flat on the scanner glass. On the other hand, a CIS has a smaller form factor, which means it is generally smaller in size and less expensive than a CCD.

There are many manufacturers of sensors. Depending on the manufacturer and the type of sensor, the interface timings of the various sensors vary considerably.

Because of the difference in interface timings, in the past, a control circuit had to be specially designed and dedicated for each type of sensor and each manufacturer to control shifting of data out of the sensor. Thus, a control circuit designed for controlling data shifting out of a CCD would not work for a CIS, and vice versa. Also, a control circuit designed for controlling data shifting out of a CCD or a CIS made by one manufacturer would not work for a CCD or CIS made by another manufacturer.

Since there are a number of different types of image sensors available from different manufacturers, it would be desirable to have a control circuit that is adaptable to any of the image sensors. This would provide flexibility in the selection of an image sensor for use in a device, such as a scanner.

### SUMMARY

It is an object of the present invention to provide a control circuit that is adaptable to different types of image sensors made by different manufacturers. It is a further object to provide flexibility in the selection of an image sensor for use in a device.

According to exemplary embodiments, this and other objects are met by a method and apparatus for controlling shifting of data out of at least one image sensor. A sequencer table is programmed with a pattern for controlling shifting of data out of a particular image sensor and for controlling sampling of shifted data. The pattern programmed into the sequencer table depends upon the image sensor. A sequencer control block controls the output of the sequencer table to control shifting of data out of the particular image sensor and sampling of the shifted data. The pattern is delivered from the sequencer table to an image sensor interface to control shifting of data out of the image sensor and to an analog front end to control sampling of shifted data. According to an exemplary embodiment, the sequencer table and the sequencer control block may be included in an application specific integrated circuit.

### BRIEF DESCRIPTION OF THE DRAWINGS

FIG. 1 illustrates an apparatus for controlling data shifting and sampling according to an exemplary embodiment;

FIG. 2 illustrates an exemplary waveform pattern for controlling data shifting and sampling according to an exemplary embodiment;

FIG. 3 illustrates an exemplary method for controlling shifting of data out of at least one image sensor and sampling of the shifted data according to an exemplary embodiment; and

FIG. 4 illustrates in more detail an exemplary process for providing a pattern for controlling data shifting and sampling of shifted data.

### DETAILED DESCRIPTION

According to exemplary embodiments, a method and apparatus are provided for controlling shifting of data out of at least one image sensor using a programmable sequencer table. In addition, according to exemplary embodiments, sampling of the shifted data may be controlled. The apparatus may be implemented as part of an Application Specific Integrated Circuit (ASIC) for controlling a multifunction device, e.g., a printer/scanner/copier.

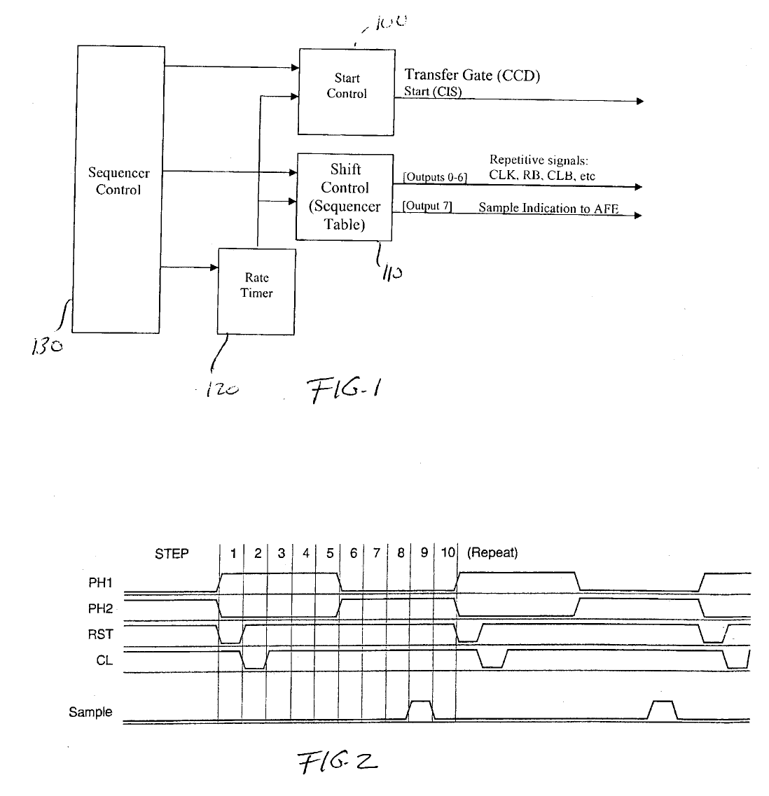

FIG. 1 illustrates an implementation of an apparatus for controlling data shifting and sampling according to an exemplary embodiment. The apparatus includes a start control block 100, a shift control block 110, a rate timer 120, and a sequencer control block 130.

The start control block 100 controls the start phase of data shifting, which involves the assertion of a signal that only transitions at the beginning of data transfer. According to an exemplary embodiment, data is shifted out of the image sensor one line at a time. Because the start phase signal is not repeated throughout the shifting of the line, it does not lend itself to the use of the sequencer table. Thus, the start control block 100 includes logic for producing this signal separately.

As might be expected, there are differences in the methods used to control different types of sensors. The most notable difference is in the start phase. For example, for a CCD, Transfer Gate signals are asserted during the start phase to control data shifting. While the Transfer Gate is active, the clock to the CCD does not change. For a CIS, the start pulse begins the process, but the clock continues to run during this time. The start control block 100 contains logic that allows for either scenario.

The shift control block 110 controls data shifting after the start phase is complete. The signaling in the shift phase is wholly repetitive and lends itself well to the use of a sequencer. Thus, the shift control block 110 includes a sequencer table for outputting a predefined pattern for controlling a sequence for data shifting and sampling of shifted data. The exemplary outputs from the shift control block 110 shown in FIG. 1 are described in more detail below.

According to an exemplary embodiment, the control pattern is programmed into the sequencer table in advance, based on the type of image sensor being used.

The pattern programmed into the sequencer table includes steps, each step defined in a register. A step represents one state, or event, of the sequence. Each bit position in the register serves to control a specific signal for data shifting out of an image sensor. Also, there may be one or more bit positions in the register for controlling data sampling by the AFE.

The rate timer 120 controls timing of the output of the start control block 100 and the shift control block 110, based, e.g., on the timing requirements of the image sensor and image sensor interface. The rate timer 120 is programmable, depending upon the timing requirement of the type of image sensor being used.

The rate timer 120 defines the duration of each step in the sequencer table in the shift control block 110. This duration may be applied to all steps. This provides the flexibility to meet the different timing requirements of many types of image sensors made by different manufacturers.

Instead of one rate timer as shown in FIG. 1, multiple rate timers may be used, each producing a unique duration period. Those duration periods may be applied to different steps in the sequencer table to allow for steps of varying duration.

The start control block 100, shift control block 110 and rater timer 120 are controlled by the sequencer control 130. According to an exemplary embodiment, the sequencer control block 130 includes a control register for this purpose. The control register may be programmed in advance via firmware.

According to an exemplary embodiment, the sequencer control block 130 adjusts the rate timer 120 depending upon the type/manufacturer of the image sensor being used and selects the CCD/CIS mode. The sequencer control block 130 also makes other adjustments needed, depending on requirements of a manufacturer. For example, in some designs, signals are inverted at the sensor. The sequencer control block 130 may compensate for this by inverting the same signal at the output of the sequencer.

In addition, the sequencer control block 130 programs the default states of the outputs. The default states register defines the state that each sequencer output assumes while the sequencer is not active.

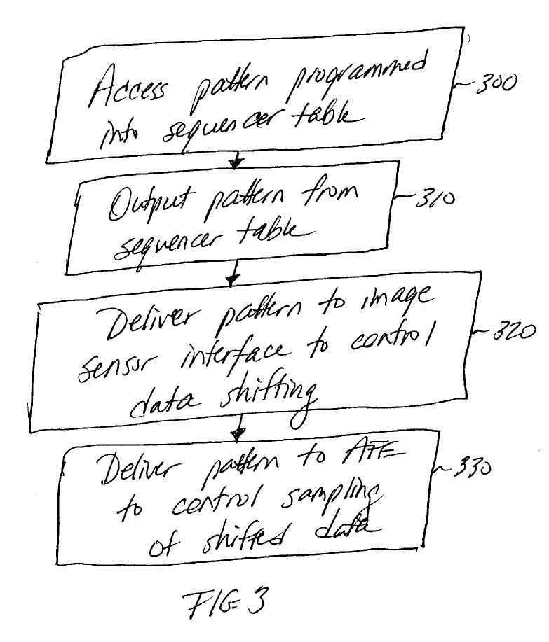

To demonstrate how the sequencer table is used, an exemplary waveform output based on a pattern stored in the sequencer table is shown in FIG. 2. This pattern may be output to control, e.g., a CCD interface.

In FIG. 2, PH1 represents the phase 1 clock of the CCD, PH2 represents the phase 2 clock of the CCD, 180 degrees out of phase from PH1, RST indicates Reset, CL indicates line clamp, and SAMP indicates sample signal to the AFE. It is clear from FIG. 2 that only four of the seven available outputs are necessary to drive the CCD sensor and control sampling by the AFE. With a little further inspection, it is evident that this pattern repeats after 10 unique steps. This means that the control function should only be programmed to use 10 entries of the table before repeating the pattern.

Tables 1 and 2 show sequencer table contents resulting in the waveform output illustrated in FIG. 2.

Table 1 shows an exemplary default register setting. In Table 1, bit 7 is the AFE Sample position, and the default is always 0 (inactive).

TABLE 1

| 7 | 6 | 5 | 4 | 3 | 2 | 1 | 0 | |
|---|---|---|---|---|---|---|---|---|
| Sample | (n/a) | (n/a) | (n/a) | CL | RST | PH2 | PH1 | (Hex) |
| (0) | 0 | 0 | 0 | 1 | 1 | 1 | 0 | 0E |

Table 2 shows an exemplary pattern that may be programmed into the sequencer using the default settings shown in Table 1.

TABLE 2

| | 7 | 6 | 5 | 4 | 3 | 2 | 1 | 0 | |
|---|---|---|---|---|---|---|---|---|---|
| Step | Sample | (n/a) | (n/a) | (n/a) | CL | RST | PH2 | PH1 | (Hex) |
| 1 | 0 | 0 | 0 | 0 | 1 | 1 | 0 | 1 | 0D |
| 2 | 0 | 0 | 0 | 0 | 1 | 0 | 0 | 1 | 09 |
| 3 | 0 | 0 | 0 | 0 | 1 | 1 | 0 | 1 | 0D |
| 4 | 0 | 0 | 0 | 0 | 0 | 1 | 0 | 1 | 05 |
| 5 | 0 | 0 | 0 | 0 | 1 | 1 | 0 | 1 | 0D |
| 6 | 0 | 0 | 0 | 0 | 1 | 1 | 1 | 0 | 0E |
| 7 | 0 | 0 | 0 | 0 | 1 | 1 | 1 | 0 | 0E |
| 8 | 0 | 0 | 0 | 0 | 1 | 1 | 1 | 0 | 0E |
| 9 | 1 | 0 | 0 | 0 | 1 | 1 | 1 | 0 | 8E |
| 10 | 0 | 0 | 0 | 0 | 1 | 1 | 1 | 0 | 0E |

According to an exemplary embodiment, the table includes a comment line that indicates which sensor signal is controlled by the corresponding bit in the sequencer register. In this example, bits 0 through 6 can be used to drive any of the signals on the sensor interface (defined by the user), while bit 7 is reserved to provide the sample indication to the AFE circuit. The HEX column provides the hex representation of each state, which may be used by firmware to write into the sequencer register to program state.

In the sequencer table represented in Table 2, there are 10 steps shown. These re active sequence steps. It will be appreciated that the sequencer table may contain as many steps as desired, to accommodate the patterns needed to control various types of image sensors.

For example, according to one embodiment, the sequencer table may include 36 steps, each step defined in one 8-bit register. This implies that up to eight signals can be manipulated in each step, and up to 36 unique steps can be taken before repeating the sequence.

According to an exemplary embodiment, the number of active sequence steps (entries in the table) may be programmed in advance by the user, via that sequencer control block. Also, the width and/or length of the sequencer table may be adjusted in advance by the user, via the sequencer control block, as desired to accommodate the requirements of the design.

In addition, although the example above describes programming of a single pattern into sequencer table, it will be appreciated that multiple patterns may be programmed into the sequencer table via the sequencer control block for controlling various sensors.

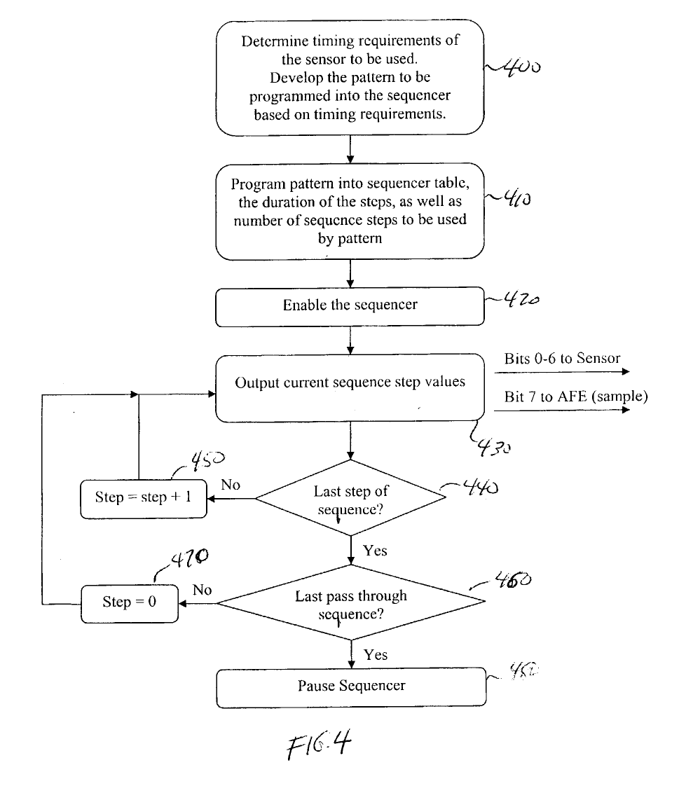

FIG. 3 illustrates an exemplary method for controlling shifting of data out of an image sensor and sampling of shifted data. The method begins at step 300 at which a pattern programmed into a sequencer table is accessed for controlling shifting of data out of an image sensor. According to an exemplary embodiment, the pattern is programmed into the sequencer table in advance, depending upon the type of the image sensor. At step 310, the pattern is output from the sequencer table. At step 320, the pattern is delivered to an image sensor interface to control data shifting. At step 330, the pattern is delivered to the AFE for controlling sampling of the shifted data According to an exemplary embodiment, only the portion of the pattern used for controlling data shifting is delivered to the image sensor interface in step 320, and only the portion of the pattern used for controlling sampling of the shifted data is delivered to the AFE in step 330. For example, referring to the exemplary pattern described above, bits 0-6 are delivered to the image sensor interface to control data shifting, and bit 7 is delivered to the AFE to control sampling of the shifted data.

FIG. 4 illustrates in more detail an exemplary process for providing a pattern for controlling data shifting and sampling of shifted data. First, at step 400, the timing requirements of the sensor to be used are determined, and the pattern to be programmed into the sequencer is developed, based on the timing requirements. Next, at step 410, the pattern is programmed into the sequencer table. Also, the duration of the steps and the number of sequence steps to be used by the pattern are programmed into the sequencer. The sequencer is then enabled at step 420.

Steps 430-480 are used in outputting the sequence steps values for controlling data shifting and sampling. At step 430, the current sequence step value is output. Using the exemplary pattern described above, sequence step values for bits 0-6 are output for delivery to the sensor for controlling data shifting, and bit 7 is output for delivery to the AFE to control sampling of shifted data. At step 440, a determination is made whether the last step of the sequence has been reached. If not, the step is incremented by 1 at step 450, and step 430 is repeated. If the last step of the sequence has been reached, a determination is made at step 460 whether the last pass through the sequence has been performed. If not, the sequence needs to be repeated, so at step 470 the step is set to 0 and the process returns to step 430. If the last pass through the sequence has been performed, the sequencer is paused at step 480.

According to exemplary embodiments, a sequencer table is used to provide significant flexibility in defining the signal patterns for controlling data shifting and sampling. The use of a programmable sequencer makes the task of supporting multiple sensors from multiple vendors more tenable.

Although a CCD and a CIS are referred to in the description above, it will be appreciated that the invention is not limited to these applications but is applicable to any type of image sensor.

It should be understood that the foregoing description and accompanying drawings are by example only. A variety of modifications are envisioned that do not depart from the scope and spirit of the invention. The above description is intended by way of example only and is not intended to limit the present invention in any way.

What is claimed is:

1. An apparatus for controlling shifting of data out of different image sensors, the apparatus comprising:
a sequencer table programmed with a pattern for controlling shifting of data out of a particular image sensor, wherein the pattern programmed into the sequencer table depends upon the particular image sensor, and
a sequencer control block for controlling the output of the sequencer table to control shifting of data out of the particular image sensor.

2. The apparatus of claim 1, wherein at least a portion of the pattern is delivered from the sequencer table to an image sensor interface to control shifting of data out of the image sensor.

3. The apparatus of claim 2, wherein the pattern programmed into the sequencer table depends on timing requirements of the image sensor interface.

4. The apparatus of claim 1, wherein the sequencer table and the sequencer control block are included in an application specific integrated circuit.

5. The apparatus of claim 1, wherein the pattern programmed into the sequencer table also controls sampling of the data shifted out of the image sensor.

6. The apparatus of claim 5, wherein the pattern programmed into the sequencer table includes information indicating when to sample the data shifted out of the image sensor.

7. The apparatus of claim 5, wherein a portion of the pattern for controlling shifting of data out of the image sensor is delivered from the sequencer table to an image sensor interface, and a portion of the pattern for controlling sampling of shifted data is delivered from the sequencer table to an analog front end.

8. The apparatus of claim 1, wherein the pattern programmed into the sequencer table includes steps.

9. The apparatus of claim 8, wherein each step represents one state of a sequence of shifting data out of the image sensor and sampling shifted data.

10. The apparatus of claim 8, further comprising at least one rate timer for defining the duration of each step in the sequencer table.

11. The apparatus of claim 10, wherein the sequencer control block controls the rate timer.

12. The apparatus of claim 10, wherein the same duration is defined for each step.

13. The apparatus of claim 10, wherein the sequencer control block controls multiple rate timers for defining different durations for different steps.

14. The apparatus of claim 8, wherein the number of steps in the sequencer table is adjustable.

15. The apparatus of claim 14, wherein the sequencer control block determines the number of steps.

16. The apparatus of claim 1, wherein the number of patterns in the sequencer table is adjustable.

17. The apparatus of claim 1, wherein the image sensor is included in a scanner.

18. The apparatus of claim 1, wherein the image sensor is a charge coupled device (CCD).

19. The apparatus of claim 1, wherein the image sensor is a contact image sensor (CIS).

20. A method for controlling shifting of data out of different image sensors, the method comprising:
accessing a pattern programmed into a sequencer table for controlling shifting of data out of a particular image sensor, wherein the pattern programmed into the sequencer table depends upon the particular image sensor; and
outputting the pattern from the sequencer table for controlling shifting of data out of the at least one image sensor.

21. The method of claim 20, wherein at least a portion of the pattern is delivered from the sequencer table to an image sensor interface to control shifting of data out of the image sensor.

22. The method of claim 21, wherein the pattern programmed into the sequencer table depends on timing requirements of the image sensor interface.

23. The method of claim 20, wherein a sequencer control block controls the output of the pattern from the sequencer table.

24. The method of claim 23, wherein the sequencer control block and the sequencer table are included in an application specific integrated circuit.

25. The method of claim 20, further comprising controlling sampling of the data shifted out of the image sensor.

26. The method of claim 25, wherein the pattern programmed into the sequencer table includes information indicating when to sample the data shifted out of the image sensor.

27. The method of claim 25, wherein a portion of the pattern for controlling shifting of data out of the image sensor is delivered from the sequencer table to an image sensor interface, and a portion of the pattern for controlling sampling of shifted data is delivered from the sequencer table to an analog front end.

28. The method of claim 20, wherein the pattern in the sequencer table includes steps.

29. The method of claim 28, wherein each step represents one state of a sequence of shifting data out of the image sensor and sampling shifted data.

30. The method of claim 28, wherein the step of providing the pattern includes defining the duration of each step in the sequencer table.

31. The method of claim 30, wherein the same duration is defined for each step.

32. The method of claim 30, wherein different durations are defined for different steps.

33. The method of claim 30, wherein the number of steps in the sequencer table is adjustable.

34. The method of claim 20, wherein the number of patterns in the sequencer table is adjustable.

35. The method of claim 20, wherein the image sensor is included in a scanner.

36. The method of claim 20, wherein the image sensor is a charge coupled device (CCD).

37. The method of claim 20, wherein the image sensor is a contact image sensor (CIS).
